(19) United States
(12) Patent Application Publication
(10) Pub. No.: US 2025/0083694 A1
(43) Pub. Date: Mar. 13, 2025

(54) SYSTEMS AND METHODS FOR FORMAL VERIFICATION OF CORNER CASES FOR AUTONOMOUS VEHICLES

(71) Applicant: TOYOTA MOTOR ENGINEERING & MANUFACTURING NORTH AMERICA, INC., PLANO, TX (US)

(72) Inventors: JUSTIN SANCHEZ, Mountain View, CA (US); ROHIT GUPTA, Santa Clara, CA (US); NEJIB AMMAR, San Jose, CA (US); AKILA C. GANLATH, San Jose, CA (US); SHATADAL MISHRA, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/465,935

(22) Filed: Sep. 12, 2023

(51) Int. Cl. B60W 60/00

(52) U.S. Cl. CPC B60W 60/001; G06N 20/00

(57) ABSTRACT

Systems and methods are provided that implement virtual dataset creation and formal verification for artificial Intelligence (AI)/Machine Learning (ML) models in a manner that improves the performance of AI/ML models when encountering corner cases. For example, a corner case correction system is configured to synthesize new samples by recontextualizing samples related to corner cases, in new environments. The corner case correction system can implement an energetic neural process which separates input data into contextual features and content, and then recombines the context and content to synthesize new samples, generating a virtual dataset. The energetic neural process also performs a formal verification of the AI/ML models to address noise in the virtual dataset. The AI/ML model is trained using the virtual dataset, and an updated AI/ML model is created to execute predictive analysis for the corner cases associated with driving environments of autonomous vehicles.

### TECHNICAL FIELD

The present disclosure relates generally to systems and methods of artificial intelligence (AI) and data analysis for automotive applications. Specifically, some implementations relate to formal verification of corner cases in AI mechanisms for autonomous vehicles.

### DESCRIPTION OF RELATED ART

In the realm of artificial intelligence (AI), corner cases can be considered as unusual and/or atypical input that can cause unexpected performance from an AI model or system. Corner cases can arise when an AI model encounters input data that falls outside of the range of what the model was primarily trained on, or when the inputs exhibit a complex and/or rare pattern that the model has not previously seen. Thus, corner cases are often challenging for AI systems, because they can lead to errors, incorrect predictions, or anomalous and/or unexpected outcomes.

Identifying and addressing corner cases is essential in AI development to ensure the robustness, reliability, and generalizability of the AI models. By understanding and accounting for corner cases, developers can improve the performance and safety of AI systems across a wide range of scenarios, including those rare situations that may deviate significantly from normal operations. Typically, addressing problems that can arise from corner cases involves rigorous testing, data collection, and iterative model improvements in an attempt to handle diverse inputs effectively and minimize unexpected behaviors. Accordingly, it may be beneficial to develop techniques that particularly address corner cases encountered by AI systems used in automotive applications, such as autonomous vehicles

### BRIEF SUMMARY OF THE DISCLOSURE

In accordance with some embodiments a method for implementing formal verification of corner cases in artificial Intelligence (AI)/Machine Learning (ML) mechanisms for autonomous vehicles is described. The method comprises generating a virtual dataset from an initial dataset. The virtual dataset can include synthesized data samples for corner cases associated with driving environments of autonomous vehicles. The method can further involve training an AI/ML model using the virtual dataset, and then performing formal verification of the AI/ML model. Thereafter, the method updates the AI/ML model to execute predictive analysis for the corner cases associated with driving environments of autonomous vehicles.

In accordance with some embodiments a system for implementing formal verification of corner cases in AI/ML mechanisms for autonomous vehicles. A vehicle can be configured with a controller receiving an updated AI/ML model. The updated AI/ML model is trained for executing predictive analysis for corner cases associated with driving environments of autonomous vehicles using a virtual dataset. The controller can execute an autonomous control of the vehicle based on the updated AI/ML model. The updated AI/ML model modifies an autonomous control of the one or more deployed autonomous vehicles for the corner cases.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example illustration of a vehicle environment implementing a corner case correction system for an autonomous vehicle application, according to one embodiment.

FIG. 2 depicts a conceptual diagram of an energetic neural process implemented by the corner case correction system shown in FIG. 1, according to one embodiment.

FIG. 3 depicts an example configuration for the corner case correction system shown in FIG. 1, according to one embodiment.

FIG. 4 depicts an example vehicle implementing the corner case correction system shown in FIG. 1, according to one embodiment.

FIG. 5 depicts an example vehicle in which the systems and methods disclosed herein may be applied.

FIG. 6 depicts an example architecture of an in-vehicle corner case correction system, according to one embodiment.

FIG. 7 is an example computing component that may be used to implement various features of embodiments described in the present disclosure.

The figures are not exhaustive and do not limit the present disclosure to the precise form disclosed.

### DETAILED DESCRIPTION

For autonomous vehicles, a corner case can involve a unique or extremely rare circumstance that the autonomous vehicle may still encounter while operating in a real-world environment. Often, corner cases require special attention during development and testing prior to deployment, as an attempt to help lower the potential that an autonomous vehicle will have a catastrophic reaction (e.g., collision) when it encounters a corner case during its operation. Examples of corner cases in the realm of autonomous vehicles can include, challenging weather conditions, unusual road layouts, unexpected pedestrian behaviors, or other uncommon events that could pose difficulties for the autonomous vehicle's sensors, perception algorithms, or decision-making processes. Identifying and effectively handling corner cases is crucial for ensuring the safety and reliability of autonomous vehicles in a wide range of real-world scenarios.

The disclosed embodiments provide methods and systems that implement virtual dataset creation and formal verification for AI/ML models in a manner that improves the performance of AI/ML models when encountering corner cases. Thus, the disclosed embodiments can achieve mitigation of failures and/or anomalies in the operation of autonomous vehicles with respect to operating under conditions that involve a corner case. According to the embodiments, corner cases, which may be categorized as long-tailed (rare and unique), fine-grained (very sensitive to small details), or noisy signals, are identified that may be experienced during the operation of autonomous vehicles. As such corner cases are typically rare, it can be difficult to obtain a sufficient dataset to properly train AI/ML models to properly address a corner case when they are experienced in very infrequent instances. For instance, AI/ML models tend to underfit (e.g., unable to capture relationships between input and output variables accurately) with respect to corner cases, thus the models cannot establish a dominant trend within the data, resulting in training errors and poor performance of the model (e.g., generating a high error rate on both the training set and unseen data). If a model cannot generalize well to new data, then it cannot be leveraged for classification or prediction tasks. Generalization of a model to new data is ultimately what allows machine learning algorithms to accurately make predictions and classify data.

In order to satisfy the data requirements (e.g., sufficient dataset) related to training AI/ML models for scenarios involving corner cases, the disclosed embodiments include a distinct system that is configured to synthesize new samples by recontextualizing the few samples related to corner cases, in new environments. As disclosed herein, a corner case correction system can implement an energetic neural process which separates input data into contextual features and content, and then recombines the context and content in a manner that synthesize new samples, generating the virtual dataset. The energetic neural process can be described as including deep neural network aspects, which separate data into context and content, and energy model aspects that perform formal verification of models to address noise in the virtual dataset in a manner that allows the corner case correction system to utilize implicit generative models efficiently.

According to an embodiment, the corner case correction system is configured to initially collect low-priority issues. In order to address problems that are related to training an AI/ML model with a severely limited dataset size as it pertains to corner cases, the corner case correction system executes a distinct virtual dataset creation process. As described herein, virtual dataset creation can involve separating samples within an initial dataset (e.g., small dataset) into content and context via partial information decomposition, and then re-synthesizing the new samples by mixing the contextual information from the samples (in addition to any contextual information previously obtained) into new pairs with the content. As a result, the corner case correction system can create a virtual dataset that is substantially larger than its initial dataset and can be used for training AI/ML models to particularly handle corner cases. Thus, the disclosed embodiments update AI/ML models in a manner that is robust and enables proper function of autonomous vehicles, for example, even when encountering corner cases.

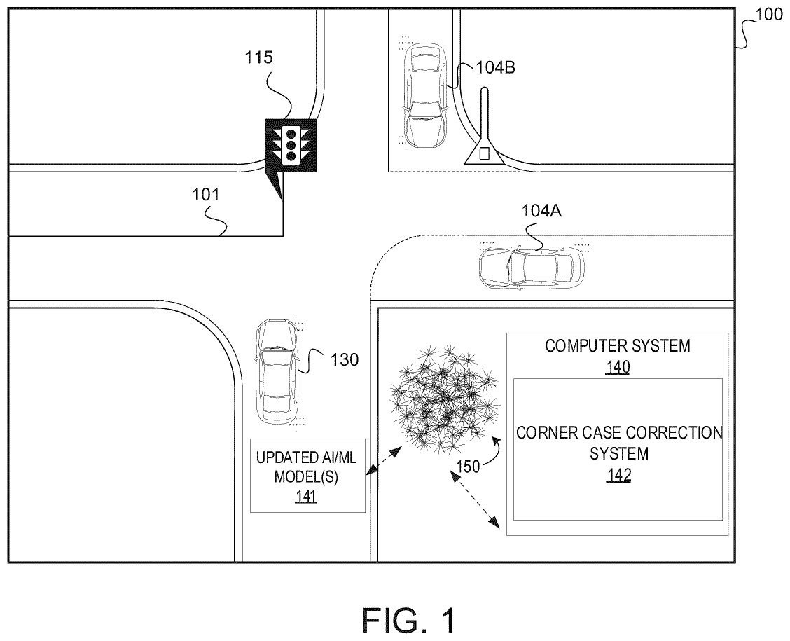

FIG. 1 depicts an example environment 100 in which the disclosed corner case correction system 142 is implemented. The corner case correction system 142 is distinctly designed to implement AI/ML algorithms that are particularly designed to have improve performance with respect to corner cases in automotive applications, particularly autonomous vehicles.

Autonomous vehicle datasets are becoming more accessible due to the increase in autonomous vehicle operations. These datasets include information such as vehicle data, videos, images, object annotations, location, status codes, thermal readings, and LiDAR. However, autonomous vehicle datasets associated with rare corner cases are extremely limited. Although there is a possibility that autonomous vehicles can encounter corner cases and/or challenging scenarios during its operational lifetime, these instances are so infrequent that there are very few datasets surrounding corner cases that are obtained by deployed autonomous vehicles that have actually experience these cases. Due to this shortage of data with respect to corner cases, the AI/ML-based software that is distributed to autonomous vehicles and controls the autonomous operation of these vehicles is typically not developed to address corner cases with high accuracy and resilience. As referred to herein, corner cases and/or challenging scenarios can include, but are not limited to: long-tailed scenarios that are rare or unique; fine-grained scenarios that are sensitive to small details; noisy scenarios; and the like.

In the operational environment 100 of FIG. 1, an example of a corner case that is being experienced by an autonomous vehicle 130 is illustrated. FIG. 1 depicts that in the operational environment 100, the autonomous vehicle 130 is approaching a traffic light 115 situated at an intersection 101. However, this intersection 101 sits at the top of a steep slope (e.g., hilltop) where the sharp incline places the traffic light 115 out of the line-of-sight of the autonomous vehicle 130, which is waiting at a lower angled point in the slope. The operational environment 100 can be a scenario that has been identified as a corner case. As an example, historical data for operational environment 100 has been obtained relating to another autonomous vehicle that encountered the same intersection 101 at an earlier time and functioned anomalously, by proceeded through the intersection 101 even while the traffic light 115 was illuminated red. The operational environment 100 may be considered a corner case because it is possible for a vehicle to be at an angle (with respect to the position of the traffic light 115) where its sensors and perception components fail to recognize the presence of the traffic light 115 because of the steepness of the slope of the road, and then as a result, erroneously performs an autonomous action, such as failing to stop at the intersection 101 when the traffic light 115 is red.

In an embodiment, vehicle 130 can be an autonomous vehicle. As used herein, “autonomous vehicle” means a vehicle that configured to operate in an autonomous operational mode. “Autonomous operational mode” means that one or more computing systems of the vehicle 130 are used to navigate and/or maneuver the vehicle along a travel route with a level of input from a human driver which varies with the operational mode. As such, vehicle 130 can have a plurality of autonomous operational modes supported by an AI/ML-based software platform that controls the autonomous operation and navigation, with a varied level of automated response. In some embodiments, the vehicle 130 can have an unmonitored autonomous operational mode. “Unmonitored autonomous operational mode” means that one or more computing systems are used to maneuver the vehicle along a travel route fully autonomously, requiring no input or supervision required from a human driver. Also, according to the embodiments, the autonomous vehicle 130 is equipped with AI/ML-based software platform that employs AI/ML model(s) and/or algorithms to support the related autonomous functions and capabilities. Thus, as an unmonitored autonomous vehicle 130, responses to corner cases, such as operational environment 100 can be highly, or fully, automated. For example, the corner case correction system 142 can be configured to communicate data, such as updated AI/ML model(s) 141, that ultimately controls the vehicle 130 to operate autonomously and safely. For example, after the corner case correction system 142 generates an updated AI/ML model 141 that is communicated to the autonomous vehicle 130, the AI/ML-based software installed thereon can integrate the update to adjust its functionality and execute autonomous controls for the vehicle 130 in a manner that improves performance for corner cases. That is, autonomous vehicle 130 operating as an autonomous vehicle, can automatically perform the necessary adjustments (e.g., lane change) with any human driver interaction. Accordingly, vehicle 130 can operate with respect to computer-controlled commands, or controls (based on updated AI/ML model 141) in a fully autonomous manner.

Alternatively, or in addition to the above-described modes, vehicle 130 can have one or more semi-autonomous operational modes. “Semi-autonomous operational mode” means that a portion of the navigation and/or maneuvering of the vehicle 130 along a travel route is performed by one or more computing systems, and a portion of the navigation and/or maneuvering of the vehicle 130 along a travel route is performed by a human driver. One example of a semi-autonomous operational mode is when an adaptive cruise control system is activated. In such case, the speed of a vehicle 130 can be automatically adjusted to maintain a safe distance from a vehicle ahead based on data received from on-board sensors, but the vehicle 130 is otherwise operated manually by a human driver. Upon receiving a driver input to alter the speed of the vehicle (e.g., by depressing the brake pedal to reduce the speed of the vehicle), the adaptive cruise control system is deactivated, and the speed of the vehicle is reduced. Thus, with vehicle 130 operating as a semi-autonomous vehicle, the response to receiving an updated AI/ML model 141 can be partially automated. Alternatively, the vehicle 130 may notify a driver that driver input is necessary to perform an action controlling vehicle 130.

Accordingly, the example of FIG. 1 illustrates a corner case correction system 142 that can provide updated AI/ML model(s) 141 that are particularly trained for improved performance with respect to corner cases, where the updated AI/ML model(s) 141 are ultimately employed to control operation of autonomous vehicle 130. In the example of FIG. 1, because autonomous vehicle 130 is currently in the operational environment 100 that has been identified as a corner case, it runs the risk of its AI/ML-based software failing in this rare scenario where historical data (e.g., ML training samples) is limited. Thus, there is the potential that the autonomous vehicle 130 may operate anomalously when encountering this corner case, also failing to recognize the traffic light 115 at the top of the incline and continuing to drive through the intersection 101 when the traffic light 115 is red. There are existing methods that attempt to simply retrain the AI/ML models for a specific case corner, such as the steep slope intersection 101 of environment 100. However, these methods are largely unfeasible to be a wide-spread solution, due to the specificity of the samples and the difficulty in scaling up collection for such specific samples. Even further, the models that are trained using these existing approaches are often inaccurate and unreliable, due to the poor training using inadequately small data sets for corner cases that rarely occur in the real-world.

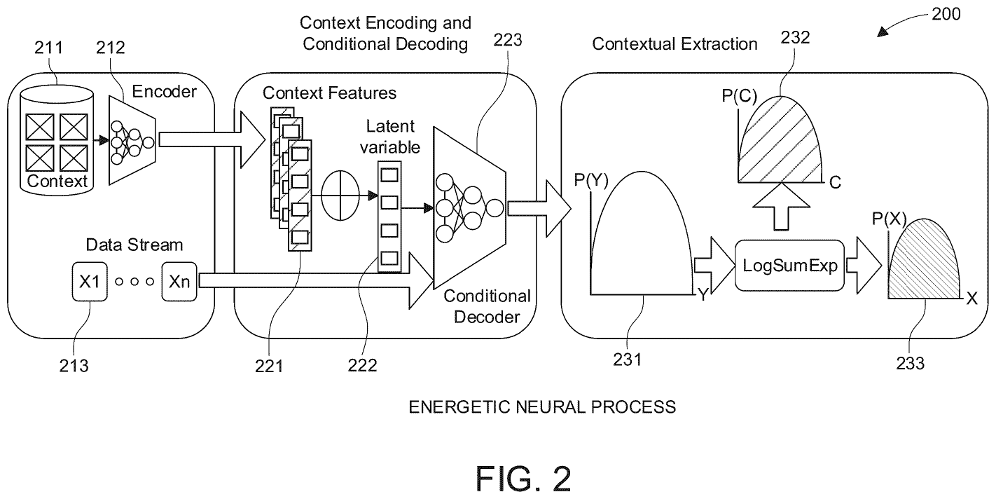

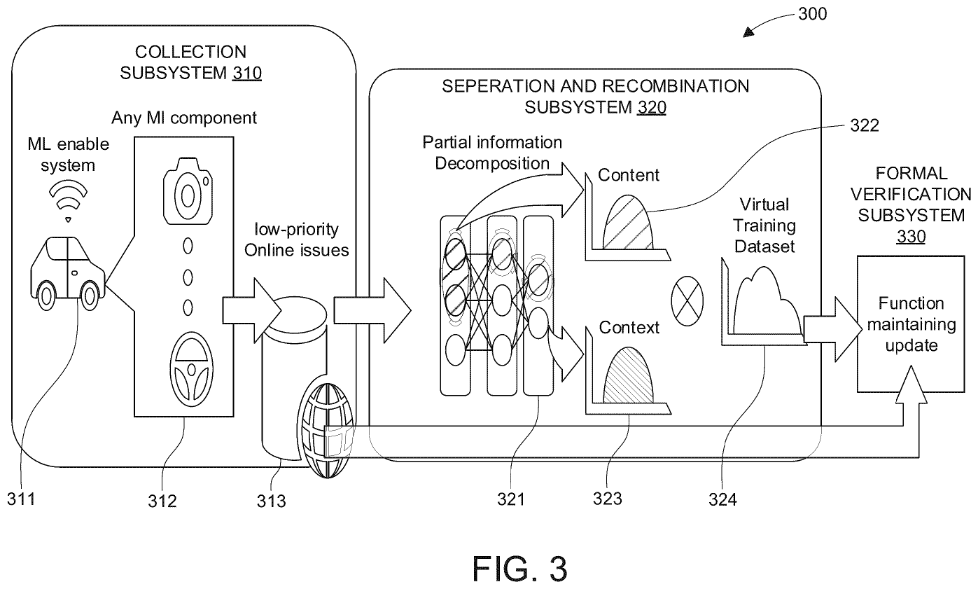

In contrast, the corner case correction system 142 is distinctly configured to perform virtual dataset creation and formal verification aspects that update AI/ML models in a manner that optimizes the performance with respect to corner cases. According to the embodiments, the corner case correction system 142 implements an energetic neural process, which synthesizes a virtual dataset by separating samples by context and content and creating new samples. Thus, by employing a robust and larger virtual dataset, the corner case correction system 142 can implement a distinct training and formal verification process which generates updated AI/ML model(s) 142 that are specifically adjusted to handle a plurality of corner cases with improved accuracy and better overall performance. The specific function and structure of the corner case correction system 142, including the energetic neural process that the system 142 implements, are described in greater detail in reference to FIG. 2 and FIG. 3, and thus are not described here regarding FIG. 1 for purposes of brevity.

Additionally, FIG. 1 shows that other vehicles 104A, 104B are also present at the intersection 101 in environment 100, and thus may have to obtained as autonomous datasets. In the example of FIG. 1, the vehicles 104A, 104B on the roadway can be sensor-rich vehicles (SRVs) that are equipped with vehicles sensors, described herein as ranging sensors (e.g., cameras, LIDAR, radar, ultrasonic sensors) and, in some cases, advanced computational resources. Also, autonomous vehicle 130 can be a SRV. Accordingly, as SRVs, vehicles 104A, 104B and 130 are enabled to utilize these advances sensors to sense various conditions on the roadway, and obtain data streams that provide content and context are pertinent to the driving environment 101, for instance capturing video (e.g., camera) of a roadway to detect objects, as well as the spatial and temporal relationships between the objects within the environment. Data collected by vehicles 104A, 104B and 130 can include, but is not limited to: vehicle identifiers; the presence of other vehicles; vehicle position; vehicle speed; vehicle movement; vehicle motion direction; road data; lane data; vehicle acceleration; other static and dynamic objects; image data; planned route data, generated HD local map, processed perception data, and the like. Additionally, the vehicles 104A, 104B and 130 can have sensor capabilities that are associated with legacy vehicles (LVs), having sensors that are capable of sensing and communicating more basic types of vehicle data, such as vehicle identifiers, vehicle location, vehicle speed, vehicle acceleration, and the like. For example, the vehicles 104A, 104B and 130 can include Global Positioning System (GPS) sensors, which can provide the basic location, velocity, and acceleration of the vehicle. Also, perception data streams can be communicated from other types of online streaming sources, such as robotic devices, unmanned ariel vehicles (UAV), and advanced driver assistance systems (ADAS). As disclosed herein, the corner case correction system 142 is configured to receive and analyze data streams associated with an operational environment, including corner cases, such as the aforementioned data that can be obtained by vehicles 104A, 104B, and 130. The function of the corner case correction system 142 with respect to collected data is described in greater detail in reference to FIG. 2 and FIG. 3, and thus are not described here for purposes of brevity.

In the example of FIG. 1, the corner case correction system 142 has performed the distinct virtual dataset creation and formal verification functions, as disclosed herein, and thus has generated updated AI/ML model(s) 141 that are trained for improved performance with respect to corner cases, including the identified corner case associated operational environment 101. Because the autonomous vehicle 130 has received the updated AI/ML model(s) 141 from the corner case correction system 142 and has accordingly updated its AI/ML-based software which controls autonomous operation, the autonomous vehicle 130 is now optimized to appropriately handle corner cases. That is, by integrating the updated AI/ML model(s) 141 into it control software, the autonomous vehicle 130 can adjust its operation to appropriately recognize the traffic light 115 at the top of the incline, thereby mitigating any errors and/or anomalous operation when encountering this corner case. For example, after receiving the updated AI/ML model(s) 141, the autonomous vehicle 130 may utilize other capabilities to become awareness of the traffic light 145 (when its camera visibility is compromised by a steep incline), and thus will autonomously brake at the traffic light 115 when it is red, avoiding a potential dangerous collision with the other vehicles 104A and 104B that are sharing the roadway at a four-way intersection 101.

Although the example of FIG. 1 describes vehicles, it should be appreciated that the corner correction system and techniques, as disclosed herein, may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types and systems as well, such as robotic devices, unmanned ariel vehicles (UAV), and advanced driver assistance systems (ADAS).

In the example of FIG. 1, the vehicle 130 in which embodiments of the disclosed technology may be implemented is illustrated. Although the example described with reference to FIG. 1 is a type of autonomous vehicle, the systems and methods described herein can be implemented in other types of vehicles including semi-autonomous vehicles, vehicles with automatic controls (e.g., dynamic cruise control), or other vehicles. Also, the example vehicle 130 described with reference to FIG. 1 maybe a type of hybrid electric vehicle (HEV). However, this is not intended to be limiting, and the disclosed embodiments can be implemented in other types of vehicles including gasoline- or diesel-powered vehicles, fuel-cell vehicles, electric vehicles, or other vehicles.

FIG. 1 illustrates a computer system 140 that is configured to implement the corner case correction system 142 and its functions. Thus, the corner case correction functions including energetic neural process, as disclosed herein, may be carried out using the computer system 140. For example, the corner case correction system 142 is implemented having substantially similar architectural framework and functionality to the systems and process described in greater detail in reference to FIG. 2 and FIG. 3. For purposes of brevity, the specific structural configuration, and detailed functions of the corner case correction system 142 are not described again in reference to FIG. 1.

Also, in the example of FIG. 1, the computer system 140 is depicted as a server, namely an edge server, within a vehicular network 150 (e.g., V2C, V2V, V2X, etc.) that supports communication between the other communicatively connected entities within the vicinity. For example, the updated AI/ML model(s) 141 and other data generated by the corner case correction system 142 can be communicate to vehicles 130, 104A, and 104B via vehicular network 150. Similarly, vehicles 130, 104A, and 104B communicate data, such as vehicle data, to computer system 140 via vehicular network 150 for implementing AI/ML-based processes at the server-end.

The computer system 140 might include one or more processors, controllers, control modules, or other processing devices, where the corner case correction system 142 is implemented as hardware processor(s). Alternatively, aspects of the corner case correction system 142 may be implemented as software on the computer system 140, such as instructions, machine-readable code, or computer program components. It should also be appreciated upon studying the present disclosure that in one or more embodiments the functions or elements of computer system 140 (including the corner case correction system 142) may reside on board a vehicle, such as autonomous vehicle 130. For example, all or part of computer system 140 may reside within vehicle 130 and their functionalities may be performed thereby.

FIG. 2 is a conceptual diagram of an energetic neural process 200 which ultimately generates updated AI/ML models that are distinctly trained for improved performance with respect to corner cases. According to the embodiments, the energetic neural process 200 implements the virtual dataset creation and formal verification functions, as disclosed herein. In order to achieve this functionality, the energetic neural process 200 can be considered to implement two key aspects, including: 1) neural process aspects which execute separation of data into context and content to ultimately generate the virtual dataset for AI/ML training; and 2) energy modeling aspects which execute formal verification in a manner that allows implicit generative models to be used efficiently. As a general description, the energetic neural process 200 synthesizes new samples for seldom seen (e.g., less data collected) corner cases, where the synthesized samples supplement the substantially small datasets that are common with rarely occurring corner case scenarios and often insufficient for properly training AI/ML-based models. Thus, the energetic neural process 200 generates a virtual dataset, and subsequently the related AI/ML models can be trained with this virtual dataset which is a more robust dataset (in comparison to an initial dataset) having a larger amount of data with respect to the corner cases thereby improving the performance of these AI/ML models. It is a core concept in the realm of AI/ML technology that employing a substantively large amount of data points in the training of a model generally results in better accuracy for the model. In contrast, training an AI/ML using small amounts of data may result in poor approximation. For example, an over-constrained model will underfit a small training dataset, resulting in poor performance. To adjust for the fewer number of data points that are obtained for infrequently occurring corner cases, the energetic neural process 200 recontextualizes the few samples it has seen, but in new environments utilizing regenerative modeling and formal verification.

FIG. 2 illustrates that the energetic neural process 200 can receive context data 211 and a data stream 213, which may be received as input to train one or more AI/ML model(s) for an autonomous vehicle application. As seen in FIG. 2, the context data 211 can be fed into an encoder 212. The energetic neural process 200 implements various AI/ML-based and/or neural networking approaches, particularly regenerative modeling, which separates samples from an initial dataset that is received by the energetic neural process 200 into content and context. FIG. 2 illustrates that the energetic neural process 200 receives input as data streams 213, which is considered content, and separate context data 211. In some cases, data streams 213 may be data collected from a plurality of on-vehicle sensors of deployed autonomous vehicles. Therefore, data streams 213 can include data, such as image data captured by on-vehicle cameras and operational vehicle parameters measured by on-vehicle sensors (e.g., speed, torque, etc.) that reflects a current environment as the autonomous vehicle is in operation, for instance while autonomously maneuvering along a city street. Due to the rarity of autonomous vehicles actually encountering corner cases result, the data stream 211 can be assumed to provide an initial dataset that has very few samples particularly pertaining to corner cases. In contrast, the context data 211 can include contextual information, such as data that is indicative of the operational environment at time when an autonomous vehicle experiences a corner case, thereby providing contextual insight to the scenario. For example, context data 211 can be historical data from autonomous vehicles associated with known or previously encountered corner cases.

The energetic neural process 200 utilizes generative models that can learn to reconstruct and sample complex data distributions, such as images, video, and audio, similar to the aforementioned data collected by an autonomous vehicle. As background, generative modeling is the task of observing data, such as images or text, and learning to model the underlying data distribution. Accomplishing this task leads models to understand high level features in data and synthesize examples that look like real data. Additionally, the generation process for these models can be controlled by specifying some desired attributes or conditions, for example data that may be pertinent to one or more corner cases.

The encoder 211 and the conditional decoder 223 can be implemented as neural networks that handle data analyzed in the energetic neural process 200, shown as context 211 and data streams 213 (content). In order to the guide generative modeling, the energetic neural process 200 also considers a conditional variable, shown as latent variable 222. For example, the encoder 211 takes the input data and produces a representation that captures the relevant context features 221 of the data given the condition. The conditional decoder 223 can take the data streams 213, context features 221 and the latent variable 222, and generate an output, namely synthesized samples, that matches the data and the condition. The conditional, or latent variable 222, can be defined in a manner that is deemed pertinent to guide the generation with respect to corner cases, such as a keywords or contextual information.

In the example of FIG. 2, context features 221 are derived from encoded context data 211, where the context features 221 are integrated into the regenerative modeling process separate from the content data, namely data streams 213. By separating the samples of the initial dataset into context information and content information, the energetic neural process 200 can later recombine the contextual information into new pairs with the content data and synthesize new samples, ultimately generating a virtual dataset that also represents conditions related to corner cases. As previously described, it is the goal of the embodiments to create a virtual dataset (used in AI/ML model training) that provides significantly more samples, through synthesis, than would otherwise be available for corner cases in the initial dataset.

FIG. 2 shows that the context features 221, latent variables 222, and the data stream 213 are input into a conditional decoder 223 for recombination and generative modeling. Consequently, the energetic neural process 200 introduces context features 221 and latent variables 222 into an enhanced encoder-decoder pre-training framework to guide the generative models and increase the relevance and diversity of responses. In other words, the conditional decoder 223 executes modeling that synthesizes the virtual dataset by separating the samples into context and content, and subsequently creating new samples through the composition of new contexts that mimics that actual data that would be generated for corner cases. Output from the conditional decoder 223 can be these synthesized samples obtained from generative modeling, which generates a virtual dataset.

In the realm of machine learning, formal verification algorithms aim to formally prove or disprove desired properties of AI/ML models, including desired properties such as safety, fault tolerance, fairness, robustness, and correctness. Because the virtual dataset has been synthesized (e.g., simulated data) there may be some unreliability in the samples, resulting in dataset errors. The errors are referred to as noise. Noise within the virtual dataset generated by the energetic neural process 200 can be detrimental to the accuracy and performance of the ML processes since the algorithm interprets the noise as a pattern and can start generalizing from it. Thus, the energetic neural process 200 also executes formal verification of the models that utilize the virtual dataset in order to correct and/or mitigate the impact of noise.

FIG. 2 illustrates that the energetic neural process 200 utilizes various energy-based models (EBM), shown as models 231-233, in order to implement the formal verification aspects. As a general description, EBM is a form of generative model. The EBMs 231-233 can represent probability distributions over data by assigning an unnormalized probability scalar (or “energy”) to each input data point, which provides useful modeling flexibility. Thus, the EBMs 231-233 can be used to learn the characteristics of a target dataset and generate similar but larger datasets. For example, the EBMs 231-233 can detect the latent variables of a dataset and generate new datasets, namely the virtual dataset for corner cases, with a similar distribution. In other words, the energetic neural process 200 retrains models (trained using the virtual dataset), where the models are formal verified to have equivalent behavior to previous models with the exception to the fixed corner cases. Consequently, the energetic neural process 200 improves the training process for AI/ML models (by creating a virtual dataset and performing formal verification) in a manner that improves the overall performance of the AI/ML models in a wide-range real-world scenarios for autonomous vehicle operation and mitigates operational failures that are often experienced when autonomous vehicles encounter rare corner cases.

FIG. 3 depicts an example architecture for implementing the structure and function of the corner case correction system 300, as disclosed herein. In the example of FIG. 3, the corner case correction system 300 has three major subsystems, including: 1) collection subsystem 310 for collecting data, for example data obtained by on-vehicle sensors of autonomous vehicles; 2) separation and recombination subsystem 320 implementing the virtual dataset creation functions to train AI/ML models for corner cases; and 3) formal verification subsystem 330 which performs a formal verification of AI/ML models to have equivalent behavior to previous models with the exception to the fixed corner cases thereby enabling updates to the AI/ML models. As a general description, the corner case correction system 300 is a computer system configured to execute the energetic neural process described above in greater detail in reference to FIG. 2.

In an embodiment, the corner case correction system 300 is implemented as a computer system, such as a server computer, that includes one or more hardware devices such as processors, controllers, control modules, or other processing devices. The functionality of the system 300 may be implemented as software on the computer system, such as instructions, machine-readable code, or computer program components. For example, the functionality of the collection subsystem 310, separation and recombination subsystem 320, and the formal verification subsystem 330 may be implemented in its entirety and embodied on the same computer system (e.g., single server). In an alternative embodiment, partial aspects of the corner case correction system 300 functionality may be distributed across one or more distinct computer systems. For example, each of the collection subsystem 310, separation and recombination subsystem 320, and the update subsystem 330 may be implemented on a separate server computer, respectively, and their functionalities may be performed thereby.

FIG. 3 illustrates that the collection subsystem 310 is configured to collect samples of various corner cases that may be seen in the real-world deployment of various AI/ML-based applications. In the example of FIG. 3, data is collected from an AI/ML-enabled system 311, shown as an autonomous vehicle. For example, data can be obtained by on-board sensors of the autonomous vehicle 311 and/or one or more of the other AI/ML-enabled elements 312 of the autonomous vehicle 311, such as a camera, steering wheel, and the like. The data that is collected by the collection subsystem 310 can be used as samples that are indicative of conditions (e.g., surrounding environment, vehicle functions) surrounding a time when the vehicle 311 is operating in a corner case scenario. For example, the collection subsystem 310 can collect data relating to an example corner case scenario, where the AI/ML system of the autonomous vehicle 311 confused light from the moon (captured by the vehicle cameras) as a yellow traffic light, and subsequently the autonomous driving actions that were performed were based on this error that the AI/ML software made in accurately observing the surrounding conditions. Continuing with this example, data collected by the collection subsystem 310 which may be deemed suitable for samples relating to this particular corner case can include information such as: multiple images obtained by the vehicle's 311 cameras; any autonomous actions performed by the vehicle; operational parameters of the autonomous vehicle (e.g., velocity); angle of the moon; and the like, for a window of time associated with the corner case.

Also, FIG. 3 shows an example embodiment for the corner case correction system 300, where the system 300 is configured to collect and analyze data associated with low-priority issues. A low-priority issue can be considered as a corner case that the autonomous vehicle 311 encounters which is deemed minor, for example not an issue that creates an eminent danger and/or resulting in any damage, human injury, or loss. In the event of a high-priority issue, human intervention may be utilized as opposed to the automated analysis performed by the system 300. For example, if the autonomous vehicle 311 encounters a corner case that caused a major collision, an engineering team may be immediately contacted to address the high-priority issues, and subsequently conduct investigation and analysis. Thus, the corner case correction system 300 can include a decision-making logic and storage, shown as database 313, which is used to analyze and maintain data associated with a scenario in order to make a determination as to whether the corner case is low-priority or high-priority. Then, based on the determination, the system 300 can continue to handle the data appropriately. As illustrated in FIG. 3, when the system 300 identifies that a corner case is a low-priority issue, the system 300 can continue with its computer-based analysis and the data that is collected by the collection subsystem 310 is passed to the separation and recombination subsystem 320 as samples for further AI/ML-based analysis.

As previously described herein, the rarity of corner cases can lead to an insufficiently small dataset to pull from for purposes of AI/ML learning. Nonetheless, the disclosed corner case correction system 300 is distinctly designed to solve this issue of limited dataset size for each instance (or issue) involving a corner case. The separation and recombination subsystem 320 is configured to employ neural networks 321 to separate the received samples into content 322 and context 323. In an embodiment, the neural networks 321 include generative models and performs the energetic neural process as described in detail above in reference to FIG. 2. Thereafter, the separation and recombination subsystem 320 executes a re-synthesis of new samples by mixing the contextual information from the samples (in addition to any contextual information previously obtained), namely context 323, in new pairs with the content 322. Therefore, the corner case correction system 300 creates a virtual dataset 324, which is substantively larger than the initial dataset of samples that was received by the system 300. Subsequently, this virtual dataset 324 can be used to train AI/ML models (used for autonomous vehicle applications) for improved performance and particularly to be more resilient to corner cases.

In some cases, the virtual dataset 324 created by the separation and recombination subsystem 320 may be subjected to noise. In order to combat the noise, the formal verification subsystem 330 is configured to perform formal verification, which ensures that AI/ML models retrained with the more robust virtual dataset 324 have equivalent behavior to previous models with the exception to the improved handling of corner cases. For instance, the formal verification subsystem 330 can implement a model verification framework that performs retraining of AI/ML models with the virtual dataset 324, while maintaining functional equivalent behavior to the previous working model with an exception being the new corrections for corner cases.

As a result, the corner case correction system 300 can generate updated AI/ML models, which have been distinctly trained for improved performance with respect to corner cases (e.g., based on newly derived virtual datasets). Thus, the AI/ML-based software that controls the operation of autonomous vehicles can be enhanced and potentially mitigates errors and/or anomalous action when encountering corner cases, by incorporating these optimized AI/ML algorithms (e.g., having improved handling of corner cases). For example, the corner case correction system 300 has the capability to store, maintain, and distribute updated AI/ML-based software that controls the operation of autonomous vehicle 311. Returning back to the example corner case involving moonlight, the autonomous vehicle 311 can be subsequently equipped with control software implementing the updated AI/ML models that have been modified by the system 300 for improved performance in corner cases (e.g., based on newly derived virtual datasets). Thus, the autonomous vehicle 311 has the capability to better distinguish between the light from the moon and light from a traffic light and continues its autonomous operation properly even in this previously problematic this scenario.

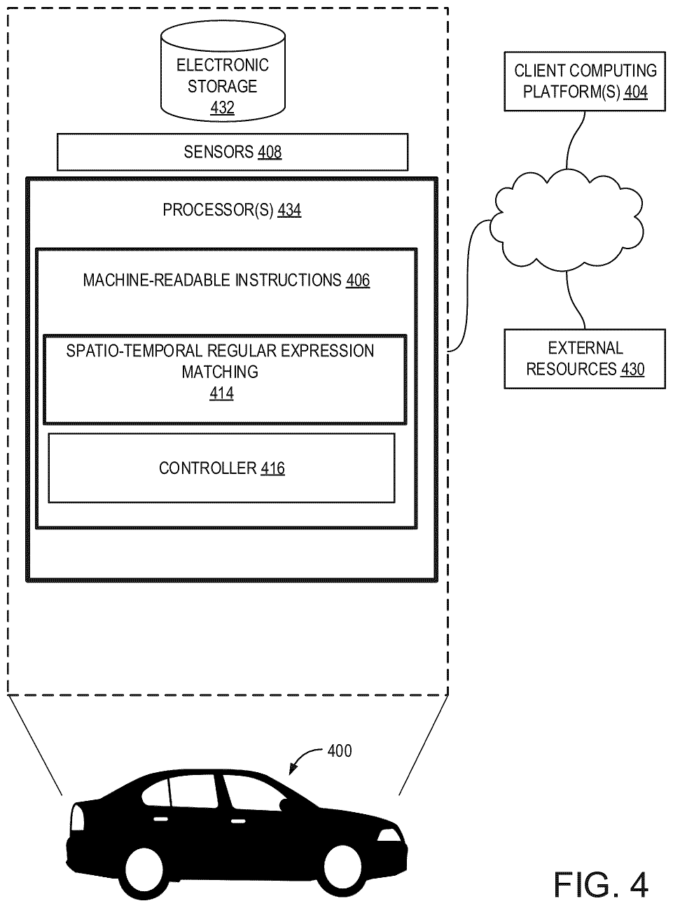

FIG. 4 illustrates a vehicle 400, for instance an autonomous vehicle, configured for implementing the disclosed case corner correction system and capabilities. In particular, FIG. 4 depicts the vehicle 400 including a case corner correction component 414. According to the disclose embodiments, the case corner correction component 414 is configured to perform functions, including virtual dataset creating, formal verification, and the energetic neural process. In some implementations, vehicle 400 may also include sensors 408, electronic storage 432, processor(s) 434, and/or other components. Vehicle 400 may be configured to communicate with one or more client computing platforms 404 according to a client/server architecture and/or other architectures. In some implementations, users may access vehicle 400 via client computing platform(s) 404.

Sensors 408 may be configured to generate output signals conveying operational information regarding the vehicle. The operational information may include values of operational parameters of the vehicle. The operational parameters of vehicle 500 may include yaw rate, sideslip velocities, slip angles, percent slip, frictional forces, degree of steer, heading, trajectory, front slip angle corresponding to full tire saturation, rear slip angle corresponding to full tire saturation, maximum stable steering angle given speed/friction, gravitational constant, coefficient of friction between vehicle 400 tires and roadway, distance from center of gravity of vehicle 400 to front axle, distance from center of gravity of vehicle 400 to rear axle, total mass of vehicle 400, total longitudinal force, rear longitudinal force, front longitudinal force, total lateral force, rear lateral force, front lateral force, longitudinal speed, lateral speed, longitudinal acceleration, brake engagement, steering wheel position, time derivatives of steering wheel position, throttle, time derivatives of throttle, gear, exhaust, revolutions per minutes, mileage, emissions, and/or other operational parameters of vehicle 400. In some implementations, at least one of sensors 408 may be a vehicle system sensor included in an engine control module (ECM) system or an electronic control module (ECM) system of vehicle 400. In some implementations, at least one of sensors 408 may be vehicle system sensors separate from, whether or not in communication with, and ECM system of the vehicle. Combinations and derivations of information (or of parameters reflecting the information) are envisioned within the scope of this disclosure. For example, in some implementations, the current operational information may include yaw rate and/or its derivative for a particular user within vehicle 400.

In some implementations, sensors 408 may include, for example, one or more of an altimeter (e.g. a sonic altimeter, a radar altimeter, and/or other types of altimeters), a barometer, a magnetometer, a pressure sensor (e.g. a static pressure sensor, a dynamic pressure sensor, a pitot sensor, etc.), a thermometer, an accelerometer, a gyroscope, an inertial measurement sensor, a proximity sensor, global positioning system (or other positional) sensor, a tilt sensor, a motion sensor, a vibration sensor, an image sensor, a camera, a depth sensor, a distancing sensor, an ultrasonic sensor, an infrared sensor, a light sensor, a microphone, an air speed sensor, a ground speed sensor, an altitude sensor, medical sensor (including a blood pressure sensor, pulse oximeter, heart rate sensor, driver alertness sensor, ECG sensor, etc.), degree-of-freedom sensor (e.g. 6-DOF and/or 9-DOF sensors), a compass, and/or other sensors. As used herein, the term “sensor” may include one or more sensors configured to generate output conveying information related to position, location, distance, motion, movement, acceleration, and/or other motion-based parameters. Output signals generated by individual sensors (and/or information based thereon) may be stored and/or transferred in electronic files. In some implementations, output signals generated by individual sensors (and/or information based thereon) may be streamed to one or more other components of vehicle 400. In some implementations, sensors may also include sensors within nearby vehicles (e.g., communicating with the subject vehicle via V to V or other communication interface) and or infrastructure sensors (e.g., communicating with the subject vehicle via the V2I or other communication interface).

Sensors 408 may be configured to generate output signals conveying visual and/or contextual information. The contextual information may characterize a contextual environment surrounding the vehicle. The contextual environment may be defined by parameter values for one or more contextual parameters. The contextual parameters may include one or more characteristics of a fixed or moving obstacle (e.g., size, relative position, motion, object class (e.g., car, bike, pedestrian, etc.), etc.), number of lanes on the roadway, direction of traffic in adjacent lanes, relevant traffic signs and signals, one or more characteristics of the vehicle (e.g., size, relative position, motion, object class (e.g., car, bike, pedestrian, etc.)), direction of travel of the vehicle, lane position of the vehicle on the roadway, time of day, ambient conditions, topography of the roadway, obstacles in the roadway, and/or others. The roadway may include a city road, urban road, highway, onramp, and/or offramp. The roadway may also include surface type such as blacktop, concrete, dirt, gravel, mud, etc., or surface conditions such as wet, icy, slick, dry, etc. Lane position of a vehicle on a roadway, by way of example, may be that the vehicle is in the far-left lane of a four-lane highway, or that the vehicle is straddling two lanes. The topography may include changes in elevation and/or grade of the roadway. Obstacles may include one or more of other vehicles, pedestrians, bicyclists, motorcyclists, a tire shred from a previous vehicle accident, and/or other obstacles that a vehicle may need to avoid. Traffic conditions may include slowed speed of a roadway, increased speed of a roadway, decrease in number of lanes of a roadway, increase in number of lanes of a roadway, increase volume of vehicles on a roadway, and/or others. Ambient conditions may include external temperature, rain, hail, snow, fog, and/or other naturally occurring conditions.

In some implementations, sensors 408 may include virtual sensors, imaging sensors, depth sensors, cameras, and/or other sensors. As used herein, the term “camera”, “sensor” and/or “image sensor” and/or “imaging device” may include any device that captures images, including but not limited to a single lens-based camera, a calibrated camera, a camera array, a solid-state camera, a mechanical camera, a digital camera, an image sensor, a depth sensor, a remote sensor, a lidar, an infrared sensor, a (monochrome) complementary metal-oxide-semiconductor (CMOS) sensor, an active pixel sensor, and/or other sensors. Individual sensors may be configured to capture information, including but not limited to visual information, video information, audio information, geolocation information, orientation and/or motion information, depth information, and/or other information. The visual information captured by sensors 208 can be in the form of digital images and/or video that includes red, green, blue (RGB) color values representing the image. Information captured by one or more sensors may be marked, timestamped, annotated, and/or otherwise processed such that information captured by other sensors can be synchronized, aligned, annotated, and/or otherwise associated therewith. For example, contextual information captured by an image sensor may be synchronized with information captured by an accelerometer or other sensor. Output signals generated by individual image sensors (and/or information based thereon) may be stored and/or transferred in electronic files.

In some implementations, an image sensor may be integrated with electronic storage, e.g., electronic storage 432, such that captured information may be stored, at least initially, in the integrated embedded storage of a particular vehicle, e.g., vehicle 500. In some implementations, one or more components carried by an individual vehicle may include one or more cameras. For example, a camera may include one or more image sensors and electronic storage media. In some implementations, an image sensor may be configured to transfer captured information to one or more components of the system, including but not limited to remote electronic storage media, e.g. through “the cloud.”

Vehicle 400 may be configured by machine-readable instructions 506. Machine-readable instructions 406 may include one or more instruction components. The instruction components may include computer program components. The instruction components may include one or more of: a leading vehicle hazard component 512; a controller 416, and/or other instruction components.

As a general description, the illustrated components within the machine-readable instructions 406 include the case corner correction component 414. As previously described in reference to FIG. 1, the case corner correction component 414 is configured to perform training of AI/ML models that is optimized for case corners in autonomous vehicle applications. Thus, the case corner correction component 514 can utilize one or more vehicle sensors 408 (e.g., camera) to capture data, such a video streams associated with case corners, which can be analyzed for improving the performance of AI/ML-based with respect to corner case.

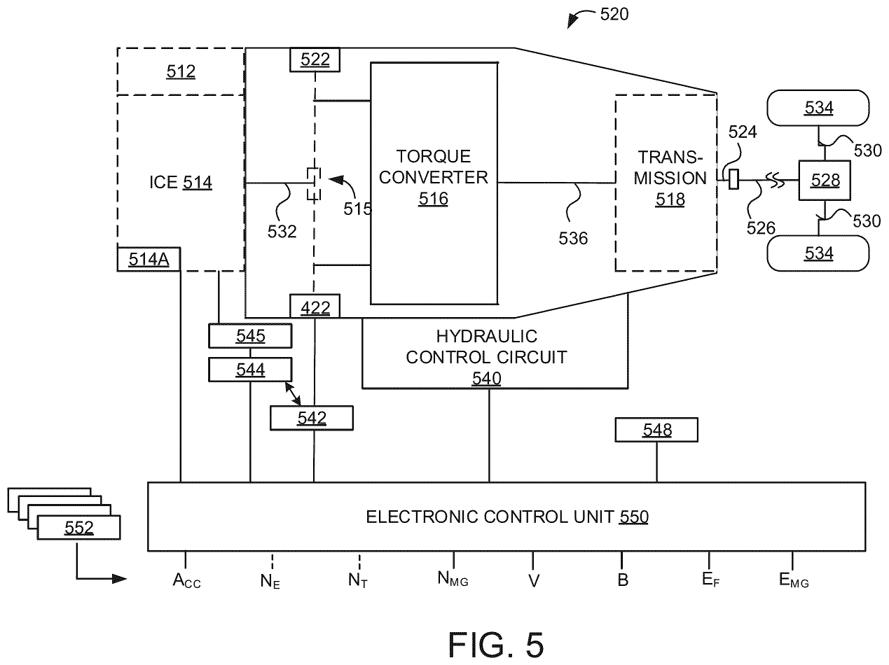

Another example vehicle in which embodiments of the disclosed technology may be implemented is illustrated in FIG. 5. The vehicle 520 may implement the autonomous vehicle and case corner correction techniques disclosed herein (as shown in FIG. 1). Additionally, the vehicle 520 can be a full electric vehicle (EV), or other type of electric-based vehicles including, fuel-cell vehicles, hybrid electric vehicles, or other vehicles.

FIG. 5 illustrates a drive system of an electric vehicle 520 that may include an EV battery 521, which stores electric powered, and one or more electric motors 522, which receive electric power from the EV battery 521, as sources of motive power. Driving force generated by the electric motors 522 can be transmitted to one or more wheels 534 via, a transmission 518, a differential gear device 528, and a pair of axles 530.

Vehicle 520 may be driven/powered with the electric motor(s) 522 as the drive source for travel. For example, a travel mode may be an EV travel mode that uses the electric motor(s) 522 as the source of motive power. Thus, in EV travel mode, vehicle 520 is powered by the motive force generated by the electric motor 522. In some implementations, another travel mode may be a hybrid electric vehicle (HEV) travel mode that uses the electric motor(s) 522 and an engine (not shown) as the sources of motive power.

As alluded to above, electric motor 522 can be used to provide motive power in vehicle 520 and is powered electrically via a battery 521 (and supplemental battery 544). Battery 521 may be implemented as one or more batteries or other power storage devices including, for example, lead-acid batteries, lithium-ion batteries, capacitive storage devices, and so on. Battery 521 may be charged by a battery charger 545. Battery 521 may also be charged by the electric motor 522 such as, for example, by regenerative braking or by coasting during which time motor 522 operate as generator.

Electric motor 522 can be powered by battery 521 to generate a motive force to move the vehicle 520 and adjust vehicle speed. Electric motor 522 can also function as a generator to generate electrical power such as, for example, when coasting or braking. Battery 521 may also be used to power other electrical or electronic systems in the vehicle. Electric motor 522 may be connected to battery 521 via an inverter 542. Battery 521 can include, for example, one or more batteries, capacitive storage units, or other storage reservoirs suitable for storing electrical energy that can be used to power the electric motor 522. When battery 521 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 550 (described below) may be included and may control the electric drive components of the vehicle as well as other vehicle components. For example, electronic control unit 550 may control inverter 542, adjust driving current supplied to electric motor 522, and adjust the current received from electric motor 522 during regenerative coasting and braking As a more particular example, output torque of the electric motor 522 can be increased or decreased by electronic control unit 650 through the inverter 542.

As alluded to above, vehicle 520 may include an electronic control unit 550. Electronic control unit 550 may include circuitry to control various aspects of the vehicle operation. Electronic control unit 550 may include, for example, a microcomputer that includes a one or more processing units (e.g., microprocessors), memory storage (e.g., RAM, ROM, etc.), and I/O devices. The processing units of electronic control unit 550, execute instructions stored in memory to control one or more electrical systems or subsystems in the vehicle. Electronic control unit 550 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS, ESC, or regenerative braking system), battery management systems, and so on. These various control units can be implemented using two or more separate electronic control units or using a single electronic control unit.

In the example illustrated in FIG. 5, electronic control unit 550 receives information from a plurality of sensors included in vehicle 520. For example, electronic control unit 550 may receive signals that indicate vehicle operating conditions or characteristics, or signals that can be used to derive vehicle operating conditions or characteristics. These may include, but are not limited to accelerator operation amount, ACC, a revolution speed, NE, rotational speed, NMG, of the motor 522 (motor rotational speed), and vehicle speed, NV. These may also include NT (e.g., output amps indicative of motor output), brake operation amount/pressure, B, battery SOC (i.e., the charged amount for battery 521 detected by an SOC sensor). Accordingly, vehicle 520 can include a plurality of sensors 552 that can be used to detect various conditions internal or external to the vehicle and provide sensed conditions to engine control unit 550 (which, again, may be implemented as one or a plurality of individual control circuits). In one embodiment, sensors 552 may be included to detect one or more conditions directly or indirectly such as, for example, fuel efficiency, EF, motor efficiency, EMG, hybrid (internal combustion engine 14+MG 12) efficiency, acceleration, ACC, etc.

Additionally, the one or more sensors 552 can be configured to detect, and/or sense position and orientation changes of the vehicle 520, such as, for example, based on inertial acceleration. In one or more arrangements, the electronic control unit 650 can obtain signals from vehicle sensor(s) including accelerometers, one or more gyroscopes, an inertial measurement unit (IMU), a dead-reckoning system, a global navigation satellite system (GNSS), a global positioning system (GPS), a navigation system, and/or other suitable sensors. In one or more arrangements, the electronic control unit 550 receives signals from a speedometer to determine a current speed of the vehicle 520.

In some embodiments, one or more of the sensors 552 may include their own processing capability to compute the results for additional information that can be provided to electronic control unit 550. In other embodiments, one or more sensors may be data-gathering-only sensors that provide only raw data to electronic control unit 550. In further embodiments, hybrid sensors may be included that provide a combination of raw data and processed data to electronic control unit 550. Sensors 552 may provide an analog output or a digital output. Additionally, as alluded to above, the one or more sensors 552 can be configured to detect, and/or sense in real-time. As used herein, the term “real-time” means a level of processing responsiveness that a user or system senses as sufficiently immediate for a particular process or determination to be made, or that enables the processor to keep up with some external process.

Sensors 552 may be included to detect not only vehicle conditions but also to detect external conditions as well. Sensors that might be used to detect external conditions can include, for example, sonar, radar, lidar or other vehicle proximity sensors, and cameras or other image sensors. In some embodiments, cameras can be high dynamic range (HDR) cameras or infrared (IR) cameras. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information. Accordingly, the one or more sensors 552 can be configured to acquire, and/or sense driving environment data. For example, environment sensors can be configured to detect, quantify and/or sense objects in at least a portion of the external environment of the vehicle 520 and/or information/data about such objects. Such objects can be stationary objects and/or dynamic objects. Further, the sensors can be configured to detect, measure, quantify and/or sense other things in the external environment of the vehicle 520, such as, for example, lane markers, signs, traffic lights, traffic signs, lane lines, crosswalks, curbs proximate the vehicle 520, off-road objects, etc.

Sensors 552 may be included to detect not only vehicle conditions but also to detect external conditions as well. Sensors that might be used to detect external conditions can include, for example, sonar, radar, lidar or other vehicle proximity sensors, and cameras or other image sensors. In some embodiments, cameras can be high dynamic range (HDR) cameras or infrared (IR) cameras. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information. Accordingly, the one or more sensors 552 can be configured to acquire, and/or sense driving environment data. For example, environment sensors can be configured to detect, quantify and/or sense objects in at least a portion of the external environment of the vehicle 520 and/or information/data about such objects. Such objects can be stationary objects and/or dynamic objects. Further, the sensors can be configured to detect, measure, quantify and/or sense other things in the external environment of the vehicle 520, such as, for example, lane markers, signs, traffic lights, traffic signs, lane lines, crosswalks, curbs proximate the vehicle 620, off-road objects, etc.

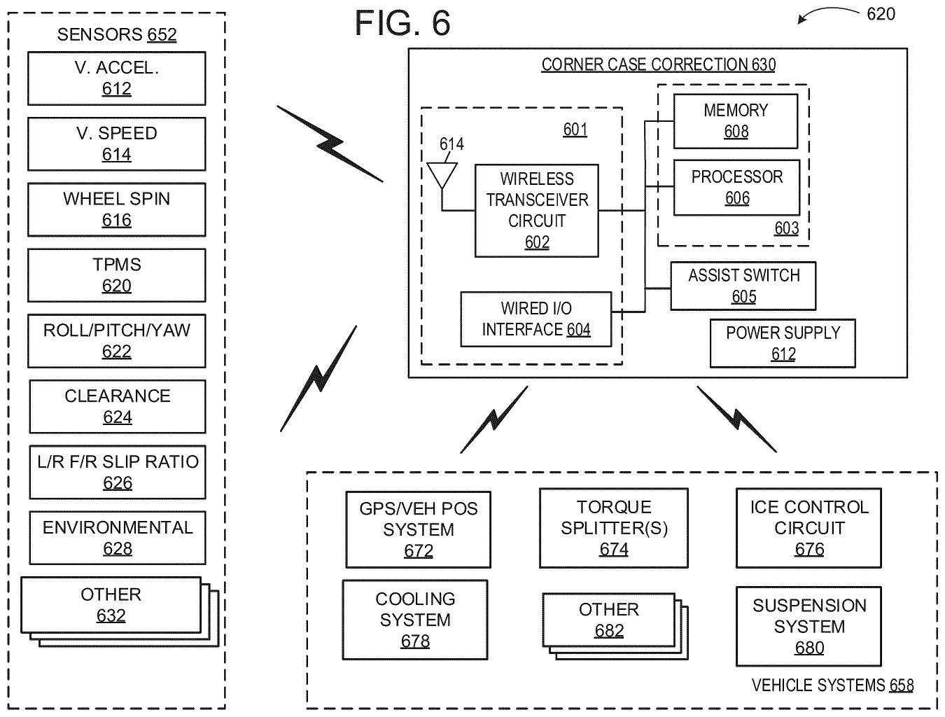

FIG. 6 illustrates an example of a case corner correction controller circuit 630 implemented in a vehicle 600 in accordance with one embodiment of the systems and methods described herein. The vehicle 600 includes a case corner correction controller circuit 630 communicatively connected to a plurality of sensors 652, a plurality of vehicle systems 658, a database 615 comprising roadway data, and a database 617 comprising right-of-way rules. Sensors 652 and vehicle systems 658 wirelessly communicate with the case corner correction controller circuit 630. Although in this example sensors 652 and vehicle systems 658 are depicted as communicating with the case corner correction controller circuit 630, they can also communicate with each other as well as with other vehicle systems. The case corner correction controller circuit 630 can be implemented as an ECU or as part of an ECU. In other embodiments, the case corner correction controller circuit 630 can be implemented independently of the ECU.

The case corner correction controller circuit 630 in this example includes a communication circuit 601, a controller/CPU 603, and a power supply 612. The controller/CPU 603 includes a processor 606 and memory 608. For example, the processor 606, and a memory 608 are configured for performing the corner case correction techniques disclosed herein.

Processor 606 can include one or more GPUs, CPUs, microprocessors, or any other suitable processing system. Processor 606 may include a single core or multicore processors. The memory 608 may include one or more various forms of memory or data storage (e.g., flash, RAM, etc.) that may be used to store instructions and variables for processor 606 as well as any other suitable information, such as, one or more of the following elements: rules data; resource data; GPS data; and base data, as described below. Memory 608 can be made up of one or more modules of one or more different types of memory, and may be configured to store data and other information as well as operational instructions that may be used by the processor 606.

Although the example of FIG. 6 is illustrated using processor and memory circuitry, as described below with reference to circuits disclosed herein, controller/CPU 703 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up the case corner correction controller circuit 630. Communication circuit 601 includes either or both a wireless transceiver circuit 602 with an associated antenna 614 and a wired I/O interface with an associated hardwired data port (not illustrated). Communication circuit 601 can provide for V2X communications capabilities, allowing the case corner correction controller circuit 630 to communicate with edge devices, such as roadside equipment (RSE), network cloud servers and cloud-based databases, and/or other vehicles.

As this example illustrates, communications with the case corner correction controller circuit 630 can include either or both wired and wireless communications circuits 601. Wireless transceiver circuit 602 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 614 is coupled to wireless transceiver circuit 602 and is used by wireless transceiver circuit 602 to transmit radio signals wirelessly to wireless equipment with which it is connected and to receive radio signals as well. These RF signals can include information of almost any sort that is sent or received by the case corner correction controller circuit 630 to/from other entities such as sensors 652 and vehicle systems 658.

Power supply 612 can include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, etc.), an energy harvester (e.g., solar cells, piezoelectric system, etc.), or it can include any other suitable power supply.

In the illustrated example, sensors 652 include vehicle acceleration sensors 621, vehicle speed sensors 622, wheelspin sensors 623 (e.g., one for each wheel), environmental sensors 628 (e.g., to detect salinity or other environmental conditions), proximity sensor 630 (e.g., sonar, radar, lidar or other vehicle proximity sensors), and image sensors 660. Additional sensors (i.e., other sensors 732) can be included as may be appropriate for a given implementation of vehicular 600.

The sensors 652 include front facing image sensors 664, side facing image sensors 666, and/or rear facing image sensors 668. Image sensors may capture information which may be used in detecting not only vehicle conditions but also detecting conditions external to the vehicle 600 as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 660 can be used to, for example, to detect objects in an environment surrounding vehicle 600, for example, traffic signs indicating a current speed limit, road curvature, obstacles, surrounding vehicles, and so on. For example, one or more image sensors 660 may capture images of neighboring vehicles in the surrounding environment. As another example, object detecting and recognition techniques may be used to detect objects and environmental conditions, such as, but not limited to, road conditions, surrounding vehicle behavior (e.g., driving behavior and the like), parking availability, etc. Additionally, sensors may estimate proximity between vehicles. For instance, the image sensors 660 may include cameras that may be used with and/or integrated with other proximity sensors 630 such as LIDAR sensors or any other sensors capable of capturing a distance. As used herein, a sensor set of a vehicle may refer to sensors 652 and image sensors 660 as a set.

Vehicle systems 658 include any of a number of different vehicle components or subsystems used to control or monitor various aspects of the vehicle and its performance. In this example, the vehicle systems 658 includes a vehicle positioning system 672; vehicle audio system 674 comprising one or more speakers configured to deliver audio throughout the vehicle; object detection system 678 to perform image processing such as object recognition and detection on images from image sensors 660, proximity estimation, for example, from image sensors 660 and/or proximity sensors, etc. for use in other vehicle systems; suspension system 680 such as, for example, an adjustable-height air suspension system, or an adjustable-damping suspension system; and other vehicle systems 682 (e.g., Advanced Driver-Assistance Systems (ADAS), such as forward/rear collision detection and warning systems, pedestrian detection systems, autonomous or semi-autonomous driving systems, and the like).

The vehicle positioning system 672 includes a global positioning system (GPS). Vehicle 600 may be DSRC-equipped vehicles. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

As used herein, the words “geographic location,” “location,” “geographic position” and “position” refer to a latitude and longitude of an object (or, a latitude, longitude, and elevation of an object), such as a connected vehicle, an RSE, a client device, etc. As used herein, the words “geographic area”, and “area,” refer to a physical space surrounding a location (e.g., an area of defined space surrounding a geographic location or geographic position). The example embodiments described herein may provide positioning information that describes a geographic position of a vehicle with an accuracy of one or more of: (1) at least plus or minus 1.5 meters in relation to the actual geographic position of the vehicle in two dimensions including a latitude and a longitude; and (2) at least plus or minus 3 meters in relation to the actual geographic position of the vehicle in an elevation dimension. Accordingly, the example embodiments described herein are able to describe the geographic position of the vehicle with lane-level accuracy or better.

Network 690 may be a conventional type of network, wired or wireless, and may have numerous different configurations including a star configuration, token ring configuration, or other configurations. Furthermore, the network 690 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 690 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VoLTE, 5G-V2X or any other mobile data network or combination of mobile data networks. Further, the network 690 may include one or more IEEE 802.11 wireless networks.

In one embodiment, data comprising the location of vehicle is captured by the vehicle position system 658. The vehicle position system 658 can include one or more sensors 652 configured to capture vehicle position data. The vehicle positioning system 672 communicates with the case corner correction controller circuit 630 to communicate and utilize knowledge at the vehicle 600 for various driving and/or maneuvering functions, including autonomous or semi-autonomous vehicle/driver safety features.

In an embodiment, the case corner correction controller circuit 630 produces notifications for the driver of the vehicle 600 using one or more notification methods. For example, the driver may receive a visual and/or audible notification that they are approaching an identified risky zone, based on case corner correction controller circuit 630 has received in accordance with knowledge networking capabilities, as disclosed herein. In one embodiment, the notification methods include the vehicle systems 658 comprising the vehicle audio system 672 and the vehicle dashboard system 676. The notification methods include visual and/or audible methods of informing the driver of safety related issues. In one embodiment, the notification methods include notifying the driver of the vehicle 600 via one or more vehicle systems 658. For example, in one embodiment, the driver is notified via the vehicle audio system 674 (e.g., instructions played/broadcasted over one or more vehicle speakers), the vehicle display system 680 and/or the vehicle dashboard system 676. In one embodiment, the driver is notified of safety issues by a navigation system within the instrument cluster and the dashboard GUI. The notification can include visual instructions (e.g., visual directions on how to proceed), and/or auditory instructions (e.g., verbal commands from the case corner correction controller circuit 630 to the driver).

Where components are implemented in whole or in part using software, these software elements can be implemented to operate with a computing or processing component capable of carrying out the functionality described with respect thereto. One such example computing component is shown in FIG. 10. Various embodiments are described in terms of this example computing component 1000. After reading this description, it will become apparent to a person skilled in the relevant art how to implement the application using other computing components or architectures.

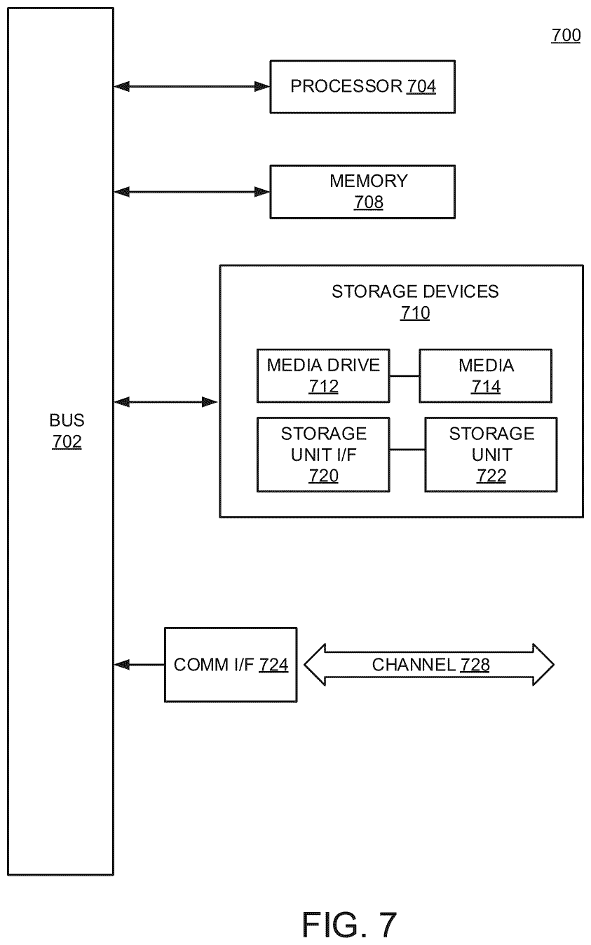

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. Processor 1004 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and the storage unit interface 1020. Examples of such storage units 722 and storage unit interfaces 720 can include a program cartridge and cartridge interface, a removable memory (for example, a flash memory or other removable memory component) and memory slot. Other examples may include a PCMCIA slot and card, and other fixed or removable storage units 722 and storage unit interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit interface 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
generating a virtual dataset from an initial dataset, wherein the virtual dataset comprises synthesized data samples for corner cases associated with driving environments of autonomous vehicles;
training an artificial Intelligence (AI)/Machine Learning (ML) model using the virtual dataset;
performing formal verification of the AI/ML model; and
updating the AI/ML model to execute predictive analysis for the corner cases associated with driving environments of autonomous vehicles.

2. The method of claim 1, wherein generating the virtual dataset comprises separating the initial dataset into content and context.

3. The method of claim 2, wherein separating the initial dataset into content and context comprises applying an energetic neural network process.

4. The method of claim 3, wherein the initial dataset comprises initial data samples for the corner cases associated with driving environments of autonomous vehicles.

5. The method of claim 4, wherein the energetic neural network process comprises synthesizing data samples for the corner cases by recontextualizing the initial data samples in the initial dataset using generative models.

6. The method of claim 5, wherein the virtual dataset for the corner cases is larger than the initial dataset for the corner cases.

7. The method of claim 6, wherein a number of synthesized data samples for the corner cases in the virtual dataset is larger than a number of initial samples for the corner cases in the initial dataset.

8. The method of claim 1, wherein the formal verification comprises maintaining functional equivalent behavior between the AL/ML trained using the virtual dataset and previous AI/ML models.

9. The method of claim 8, wherein the formal verification comprises applying energy models to the trained AI/ML model.

10. The method of claim 8, wherein the formal verification compensates for noise associated with the virtual dataset and synthesized data samples for the corner cases.

11. The method of claim 1, further comprising communicating the updated AI/ML model to one or more deployed autonomous vehicles.

12. The method of claim 11, wherein the updated AI/ML model modifies an autonomous control of the one or more deployed autonomous vehicles for the corner cases.

13. A vehicle comprising:
a controller receiving an updated artificial Intelligence (AI)/Machine Learning (ML) model, wherein the updated AI/ML model is trained for executing predictive analysis for corner cases associated with driving environments of autonomous vehicles using a virtual dataset; and
executing an autonomous control of the vehicle based on the updated AI/ML model, wherein updated AI/ML model modifies an autonomous control of the one or more deployed autonomous vehicles for the corner cases.

14. The vehicle of claim 13, wherein the controller generates the updated AI/ML model.

15. The vehicle of claim 14, wherein the controller generates the updated AI/ML model by generating a virtual dataset from an initial dataset and training an AI/ML model using the virtual dataset.

16. The vehicle of claim 15, wherein the controller performs formal verification of the AI/ML model and generates the updated AI/ML model based on the formal verification to execute predictive analysis for the corner cases associated with driving environments of autonomous vehicles.

17. The vehicle of claim 15, wherein the virtual dataset comprises synthesized data samples for corner cases associated with driving environments of autonomous vehicles.

18. The vehicle of claim 13, wherein the vehicle comprises an autonomous vehicle.

19. The vehicle of claim 13, wherein the updated AI/ML model is received from a computer system communicatively connected to the vehicle.

20. A computer system, comprising:
one or more processors; and
a memory having instructions stored thereon, which when executed by the one or more processors cause the processors to perform:
generating a virtual dataset from an initial dataset, wherein the virtual dataset comprises synthesized data samples for corner cases associated with driving environments of autonomous vehicles;
training an artificial Intelligence (AI)/Machine Learning (ML) model using the virtual dataset;
performing formal verification of the AI/ML model; and
updating the AI/ML model to execute predictive analysis for the corner cases associated with driving environments of autonomous vehicles.
